(19) United States
(12) Patent Application Publication
(10) Pub. No.: US 2018/0306586 A1
(43) Pub. Date: Oct. 25, 2018

(54) RECORDING MEDIUM, DISPLAY METHOD, AND DISPLAY APPARATUS

(71) Applicant: FUJITSU LIMITED, Kawasaki-shi (JP)

(72) Inventor: Shinya Yokoi, Kawasaki (JP)

(73) Assignee: FUJITSU LIMITED, Kawasaki-shi (JP)

(21) Appl. No.: 15/953,769

(22) Filed: Apr. 16, 2018

(30) Foreign Application Priority Data
Apr. 21, 2017 (JP) 2017-084897

(51) Int. Cl. G01C 21/20; G01C 23/00; G01P 15/18; G01P 15/08; G01S 19/47; G01S 19/52

(52) U.S. Cl. CPC G01C 21/203; G01C 23/00; G01S 19/52; G01P 15/0802; G01S 19/47; G01P 15/18

(57) ABSTRACT

A non-transitory, computer-readable recording medium stores therein a display program that causes a computer to execute a process including acquiring position information regarding changing positions of a mobile body that moves by wind power; calculating based on the position information, a speed of the mobile body at each of the positions and a running direction of the mobile body at each of the positions relative to a wind direction; accumulating information regarding the speed and the running direction; and comparing and displaying first information accumulated regarding the speed and the running direction and second information narrowed down from the first information, based on a plurality of types of tools used on the mobile body.

### CROSS REFERENCE TO RELATED APPLICATIONS

This application is based upon and claims the benefit of priority of the prior Japanese Patent Application No. 2017-084897, filed on Apr. 21, 2017, the entire contents of which are incorporated herein by reference.

### FIELD

The embodiments discussed herein are related to a recording medium, a display method, and a display apparatus.

### BACKGROUND

Generally, it is said that for a mobile body that moves by wind power such as in the case of windsurfing, sailing performance is determined by boat speed and sailing angle (angle formed by a traveling direction of the boat and the wind). It is also said that a good sailing form for efficiently catching the wind is a state in which a mast is standing while a sail is stable. If the mast swings back and forth or left and right or the drawing-in of the sail becomes weak, a change in a flow rate of the wind flowing over the sail causes the wind to escape and leads to a reduction in power, resulting in decreased speed and increased fatigue of a rider. As training to achieve a form to overcome the above situations and to improve steering techniques, operations including video recording sailing performed on the sea with a camera on shore and playing and checking the video, are repeatedly performed.

According to a related prior art, acceleration data from an acceleration sensor, a GPS signal from a GPS receiver, etc. are stored in a storage apparatus in correlation with an acquisition time, and when the acceleration data exceeds a reference value, a bridge number is extracted from moving image data to correlate a disposition position of a joint identified by the bridge number with the measurement position of the acceleration data and to display on a display of a notebook PC, an inspection screen for inspecting a road (see, e.g., Japanese Laid-Open Patent Publication No. 2015-197804).

### SUMMARY

According to an aspect of an embodiment, a non-transitory, computer-readable recording medium stores therein a display program that causes a computer to execute a process including acquiring position information regarding changing positions of a mobile body that moves by wind power; calculating based on the position information, a speed of the mobile body at each of the positions and a running direction of the mobile body at each of the positions relative to a wind direction; accumulating information regarding the speed and the running direction; and comparing and displaying first information accumulated regarding the speed and the running direction and second information narrowed down from the first information, based on a plurality of types of tools used on the mobile body.

An object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of a system configuration of a sailing training support system including a display apparatus according to an embodiment;

FIG. 2 is an explanatory diagram of an example of a hardware configuration of a sensor;

FIG. 3 is a flowchart of an example of a recording process procedure of the sensor;

FIG. 4 is an explanatory diagram of an example of a format of a GPS value;

FIG. 5 is an explanatory diagram of an example of a format of a nine-axis sensor;

FIG. 6 is a flowchart of an example of a data acquisition process procedure of the nine-axis sensor;

FIG. 7 is an explanatory diagram of an example of a format of data acquired by the sensor;

FIG. 8 is a flowchart of an example of a process procedure of data registration to a database;

FIG. 9 is a block diagram of an example of a hardware configuration of the display apparatus according to the embodiment;

FIG. 10 is a block diagram of an example of a functional configuration of the display apparatus according to the embodiment;

FIG. 11 is a flowchart of an example of a data display process procedure;

FIG. 12 is an explanatory diagram of details of classification of running data;

FIG. 13 is a flowchart of an example of an angle data calculation process procedure;

FIG. 14 is an explanatory view of details of a pitch angle calculation;

FIG. 15 is an explanatory view of details of a roll angle calculation;

FIG. 16 is an explanatory diagram of details of a yaw angle calculation;

FIG. 17 is an explanatory view of contents of data display;

FIG. 18 is an explanatory view of contents of data display;

FIG. 19 is an explanatory view of contents of data display;

FIG. 20 is an explanatory view of contents of data display;

FIG. 21 is a flowchart of an example of a tool registration/editing process procedure;

FIG. 22 is an explanatory diagram of a contents of the tool registration screen; and

FIG. 23 is an explanatory view of contents of data display.

### DESCRIPTION OF THE INVENTION

First problems associated with the related arts will be described. Windsurfing practice is often performed offshore and the conventional method has a problem in that cameras, etc. can provide only limited images as data. With consideration of the cost of practice, a person practicing may have to check her form herself. Moreover, windsurfing is a sport that deals with the “wind”, which is invisible in the first place, and an optimal sailing form itself has not yet been defined.

Embodiments of a recording medium, a display method, and a display apparatus according to the present invention will be described in detail with reference to the accompanying drawings.

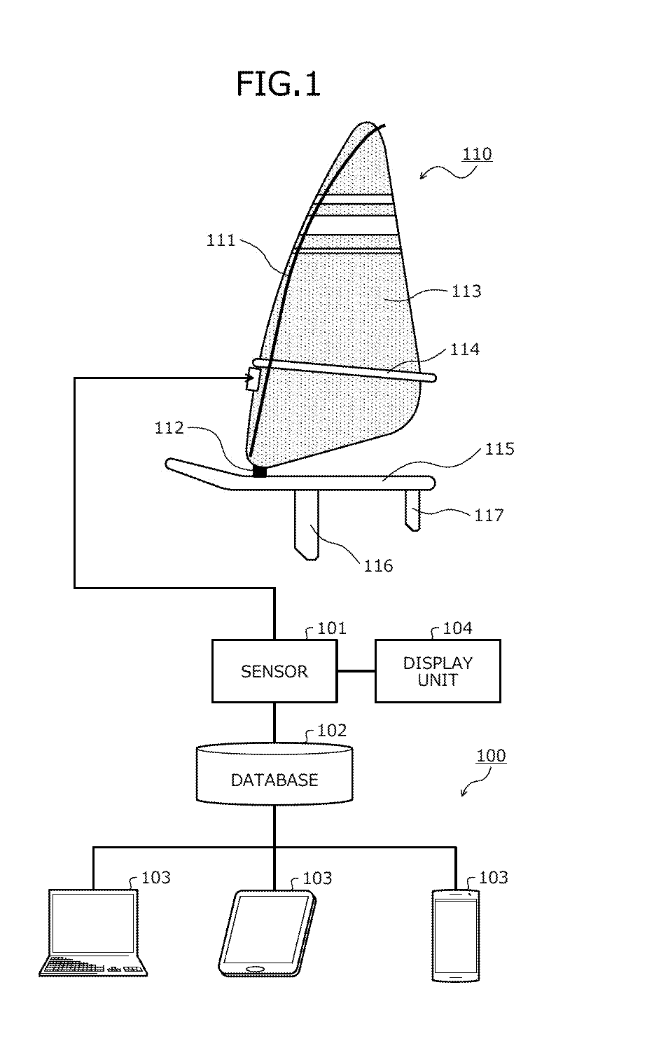

FIG. 1 is an explanatory diagram of an example of a system configuration of a sailing training support system including a display apparatus according to an embodiment. In FIG. 1, a sailing training support system 100 includes a sensor 101, a database 102, and a display apparatus 103.

In FIG. 1, a sailboard 110 is depicted as an example of a mobile body that moves by wind power, i.e., an object of sailing training. The sailboard 110 moves on water while a rider manipulates a dedicated tool in which a rig unit is attached to a board unit 115 (hereinafter, this dedicated tool will sometimes be referred to as a “mobile body 110” or a “sailboard 110”).

The rig unit includes a mast 111, a joint 112, a sail 113, and a boom 114, and the rig unit is attached to the board unit 115 by the joint 112. The board unit 115 includes a daggerboard 116 and a fin 117.

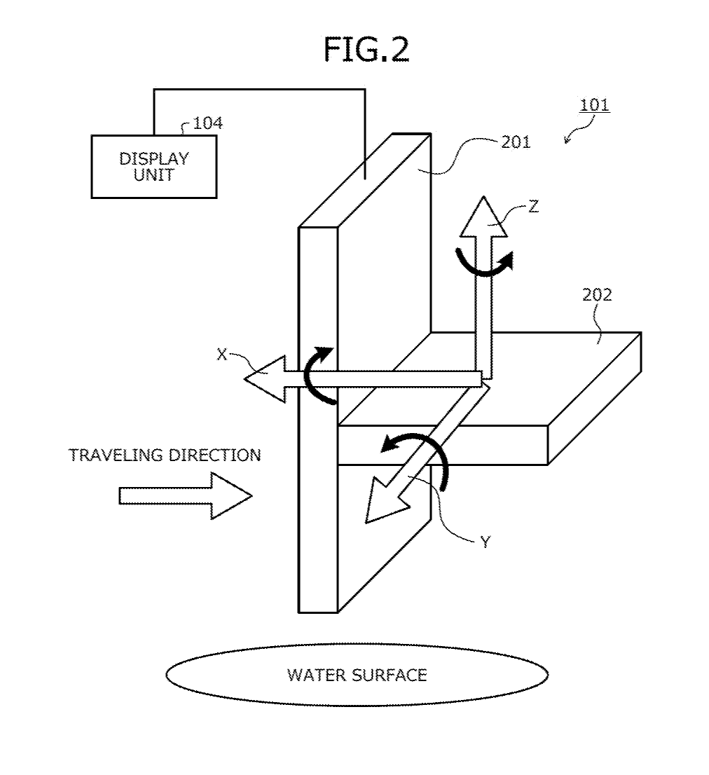

The sensor 101 is attached to the mast 111 slightly below the boom 114. The sensor 101 includes a display unit 104. Details including attachment of the sensor 101 to the mast 111 will be described later with reference to FIG. 2, etc.

In the sailing training support system 100, the sensor 101 and a database 102 are not directly connected and, for example, data acquired by the sensor 101 is stored to the database 102, through a recording medium such as an SD card not depicted. Alternatively, the sensor 101 and the database 102 may be connected by wireless communication. The sensor 101 and the database 102 may be configured to be connected through a wired or wireless network not depicted.

In the sailing training support system 100, the database 102 and the display apparatus 103 are connected through a wired or wireless network not depicted. The network may be, for example, the Internet, a mobile communications network, a local area network (LAN), or a wide area network (WAN). Therefore, the database 102 may be implemented by a cloud server not depicted. The display apparatus 103 may include the database 102.

The sensor 101 acquires positioning information regarding the position of the sailboard 110 and information regarding the state of the sail 113. The database 102 stores information acquired by the sensor 101. The display apparatus 103 displays various types of information for supporting the sailing training based on the information stored in the database 102.

The display apparatus 103 is a computer used by a user utilizing the sailing training support system 100. The display apparatus 103 is a notebook PC, a desktop PC, a tablet PC, or a smartphone, for example.

FIG. 2 is an explanatory diagram of an example of a hardware configuration of the sensor. In FIG. 2, the sensor 101 is configured to include a base 201 and a nine-axis sensor 202 (e.g., a nine-axis inertia measuring unit). The sensor 101 is connected to the display unit 104.

The nine-axis sensor 202 is provided on the base 201 attached to the mast 111 to be perpendicular to a water surface and parallel to a traveling direction. The base 201 is disposed with a GPS receiving circuit. The sensor 101 simultaneously records GPS (data indicating a running state: speed, traveling direction) and the nine-axis sensor 202 (data indicating a way of riding: three-dimensional sail handling). The sail handling (forward/backward and leftward/rightward tilting of the mast 111, rotation of the mast 111) is recorded by detecting the respective rotation angles of the nine-axis sensor 202 in the X-, Y-, and Z-directions.

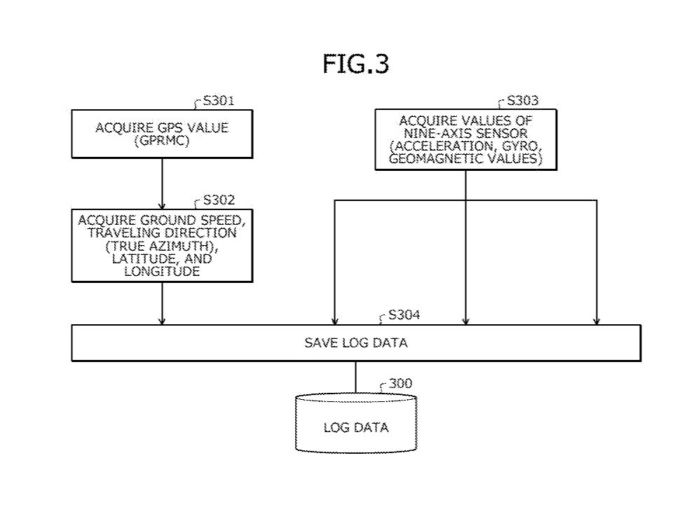

FIG. 3 is a flowchart of an example of a recording process procedure of the sensor. In the flowchart depicted in FIG. 3, the sensor 101 acquires a GPS value (GPRMC) indicating a current position (step S301). From the GPS value acquired at step S301, the sensor 101 acquires the ground speed, the traveling direction (true azimuth), the latitude, and the longitude as log data (step S302).

Simultaneously with the acquisition of the GPS value at step S301, the sensor 101 acquires a value of the nine-axis sensor 202 (step S303). For example, the sensor 101 acquires measurement values from an acceleration sensor, a gyro sensor, and a geomagnetic sensor as log data.

The sensor 101 stores the log data acquired at step S302 and the log data acquired at step S303 to a predetermined storage area (a database 300 of log data) included in the sensor 101 (step S304). The sensor 101 continuously repeats this series of processes during measurement.

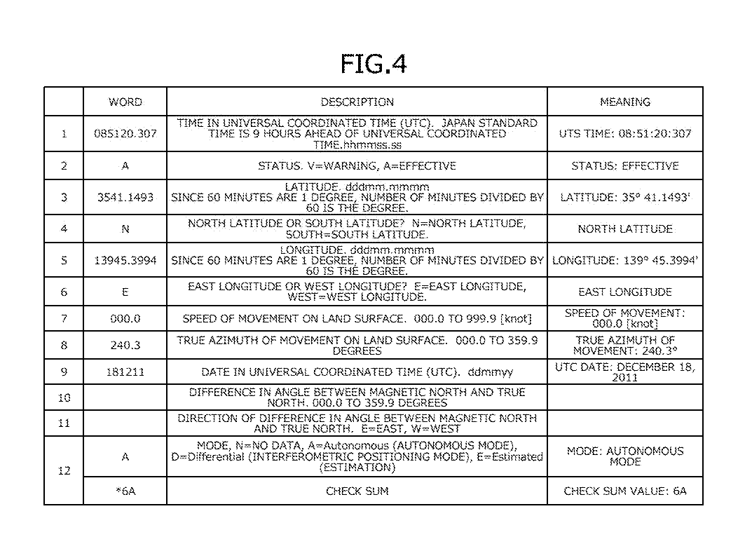

FIG. 4 is an explanatory diagram of an example of a format of the GPS value. The format depicted in FIG. 4 includes the ground speed in item 7, the true azimuth in item 8, the latitude in items 3, 4, and the longitude in items 5, 6.

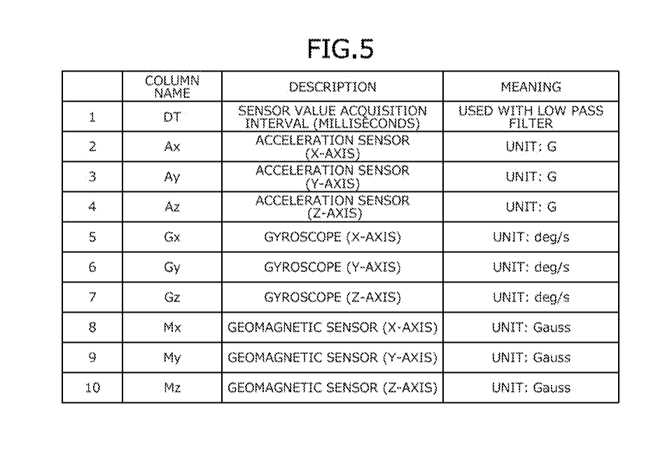

FIG. 5 is an explanatory diagram of an example of a format of the nine-axis sensor. In FIG. 5, Ax, Ay, and Az indicate the acceleration sensor (X-axis), the acceleration sensor (Y-axis), and the acceleration sensor (Z-axis), respectively. Gx, Gy, and Gz indicate the gyroscope (X-axis), the gyroscope (Y-axis), and the gyroscope (Z-axis), respectively. Mx, My, and Mz indicate the geomagnetic sensor (X-axis), the geomagnetic sensor (Y-axis), and the geomagnetic sensor (Z-axis), respectively.

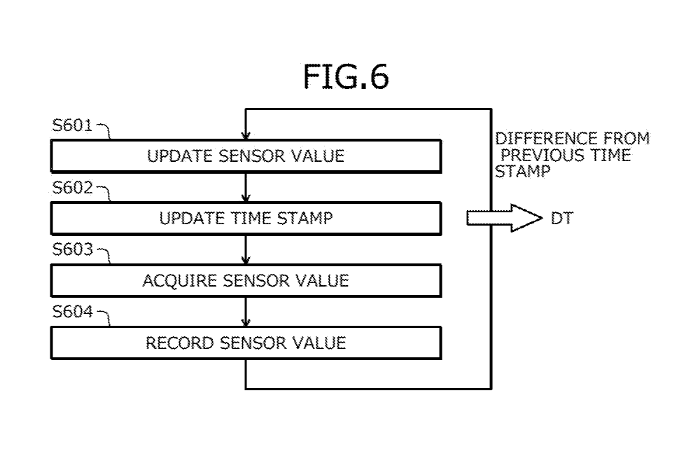

FIG. 6 is a flowchart of an example of a data acquisition process procedure of the nine-axis sensor. In the flowchart depicted in FIG. 6, the nine-axis sensor 202 first updates a sensor value (step S601) and then updates a time stamp (step S602). The nine-axis sensor 202 acquires each sensor value (step S603) and records the acquired sensor values (step S604). Subsequently, the nine-axis sensor 202 returns to step S601 and repeats steps S601 to S604.

In this way, by updating the time stamp at step S602, a difference from the previous time stamp can be obtained as DT (sensor value acquisition interval).

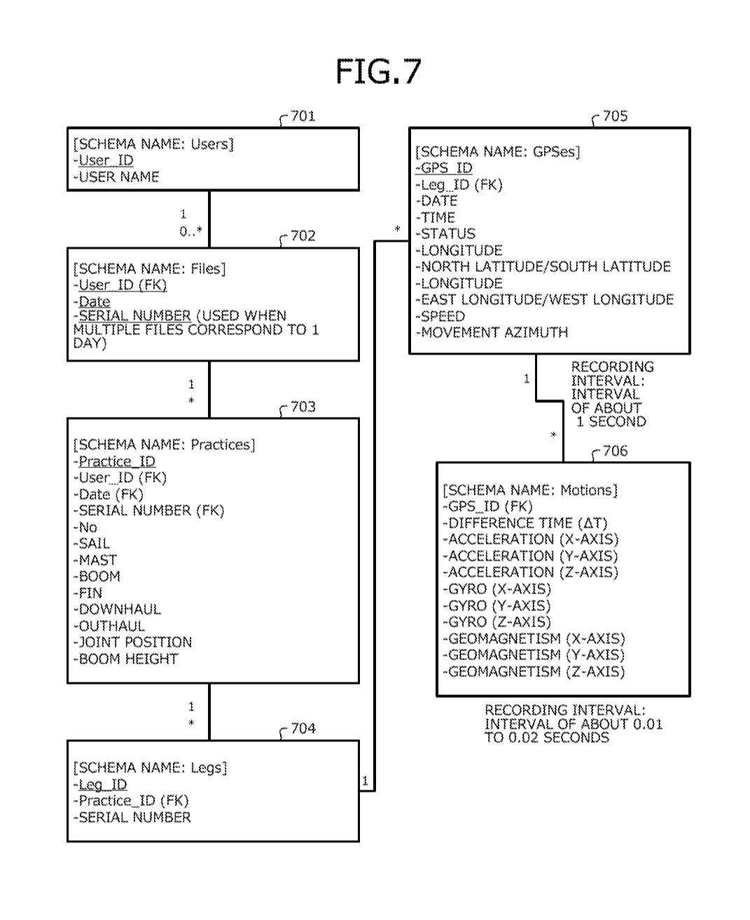

FIG. 7 is an explanatory diagram of an example of a format of data acquired by the sensor. In FIG. 7, User ID of a user is recorded in a schema 701 with a schema name: Users. Thus, the user name is recorded. In a schema 702 with schema name: Files, the User ID is recorded as a foreign key (FK), and Date (date) and a serial number (used when multiple files correspond to one day) are recorded. In other words, a file is managed by a date or a date and the serial number thereof.

In a schema 703 with a schema name: Practices, Practice ID is recorded, and the User ID, the Date, and the serial number are recorded as foreign keys (FK). Additionally, types, etc. of tools of the sailboard 110 are recorded, such as a No (a number assigned to a tool), the sail 113, the mast 111, the boom 114, the fin 117, a downhaul, an outhaul, a joint position, and a boom height.

In a schema 704 with a schema name: Legs, Leg ID is recorded, and the Practice ID is stored as a foreign key (FK). The serial number of the leg is also recorded.

In a schema 705 with a schema name: GPSes, a GPS ID is recorded, and the Leg ID is recorded as a foreign key (FK). The GPS values depicted in FIG. 4 are then recorded, such as date, time, status, longitude, north latitude/south latitude, longitude, east longitude/west longitude, speed, and movement azimuth. The schema 705 is recorded at intervals of about 1 second.

In a schema 706 with a schema name: Motions, the GPS ID is stored as a foreign key (FK). The values of the nine-axis sensor 202 depicted in FIG. 5 are stored such as difference time (AT), acceleration (X-axis, Y-axis, Z-axis), gyro (X-axis, Y-axis, Z-axis), and geomagnetism (X-axis, Y-axis, Z-axis). The schema 706 is recorded at intervals of about 0.01 to 0.02 seconds.

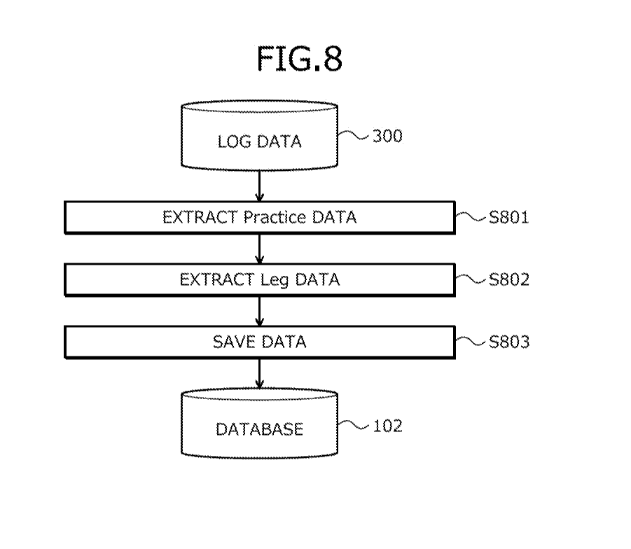

FIG. 8 is a flowchart of an example of a process procedure of data registration to the database. In the flowchart depicted in FIG. 8, first, one-day (one-time) data (data from pressing of a recording start button to pressing of a recording end button) is uploaded for each file, from the log data 300 depicted in FIG. 3.

Practice data is then extracted from the file (step S801). For example, the one-day (one-time) data is divided into pieces of data from one departure to return, and each piece of data excluding a “land waiting time” is defined as “1 Practice”. In the GPS data, when the “movement speed” is 0.5 km/h or less and the speed continues for 10 seconds or more, this is defined as the “land waiting time”.

Leg data is then extracted from the Practice data (step S802). For example, the data is divided into sections from a turn to the next turn, and if a “moving azimuth” in the GPS data is changed by a certain amount or more, five seconds after the change are recognized as “1 Leg”.

Then, extracted pieces of the Practice data and the Leg data are respectively stored (saved) in the database 102 (step S803), and the series of operations ends.

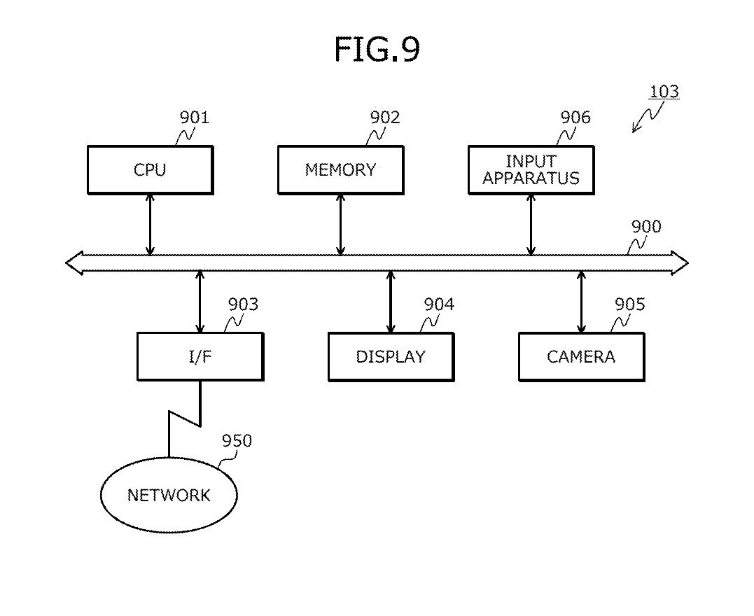

FIG. 9 is a block diagram of an example of a hardware configuration of the display apparatus according to the embodiment. In FIG. 9, the display apparatus 103 includes a CPU 901, a memory 902, an I/F 903, a display 904, a camera 905, and an input apparatus 906. The constituent units are connected by a bus 900.

The CPU 901 is responsible for the overall control of the display apparatus 103. For example, the memory 902 includes a ROM, a RAM, and a flash ROM. For example, the flash ROM or the ROM stores various programs, and the RAM is used as a work area of the CPU 901. The programs stored in the memory 902 are loaded on the CPU 901 and cause the CPU 901 to execute encoded processes.

The I/F 903 is connected through a communication line to a network 950 such as the Internet and is connected through the network 950 to the database 102 and other apparatuses including a server not depicted. The I/F 903 is responsible for interface between the network 950 and the inside of the apparatus and controls the input and output of data from other apparatuses.

The display 904 displays a cursor, an icon, or a tool box as well as data such as documents, images, and function information. For the display 904, for example, a liquid crystal display or an organic electronic Luminescence (EL) display may be adopted. The display 904 may be a head mounted display. This enables data to be presented in virtual reality.

The camera 905 is a device that takes still images or moving images. The camera may be used for taking pictures related to goods.

The input apparatus 906 has keys for inputting letters, numerals, various instructions, etc., and inputs data. The input apparatus 906 may be a keyboard, a pointing device, etc., or may be a touch panel type input pad, a numeric keypad, etc.

The display apparatus 103 may have various sensors, a hard disk drive (HDD), an SSD, etc. in addition to the constituent units described above.

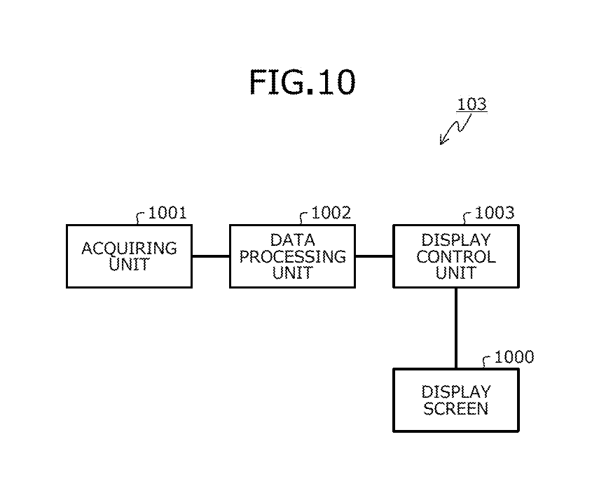

FIG. 10 is a block diagram of an example of a functional configuration of the display apparatus according to the embodiment. In FIG. 10, the display apparatus 103 includes a display screen 1000 as well as an acquiring unit 1001, a data processing unit 1002, and a display control unit 1003.

For example, a function of the display screen 1000 may be implemented by the display 904 depicted in FIG. 9, for example.

The acquiring unit 1001 receives input of position information regarding changing positions of the mobile body 110 moving by wind power, or for example, the GPS value described above. The acquiring unit 1001 also acquires state information regarding a state of the mobile body at each position, or for example, a detection value from the nine-axis sensor 202.

For example, functions of the acquiring unit 1001 may be implemented by causing the CPU 901 to execute a program stored in a storage apparatus such as the memory 902 depicted in FIG. 9 or by the I/F 903, the input apparatus 906, etc.

The data processing unit 1002 calculates the speed of the mobile unit 110 at each position based on the position information. The data processing unit 1002 calculates based on the position information, a traveling direction (e.g., abeam, close-hauled, or quarter-lee) of the mobile body 110 relative to the wind direction, at each position.

For example, functions of the data processing unit 1002 may be implemented by causing the CPU 901 to execute a program stored in a storage apparatus such as the memory 902 depicted in FIG. 9, for example.

The display control unit 1003 displays temporal changes in speed by a graph. The display control unit 1003 may display the temporal changes in speed and the traveling direction by a graph. The display control unit 1003 may display, by a graph, at least one of a highest speed and an average speed among speeds. For example, the graph may be a graph that uses a time period from a start time point and the speed at each time point in the time period as two parameters.

The display control unit 1003 may display a first mark indicating an arbitrary position on the graph and may display a second mark at a position on a movement locus of the mobile body 110 on a map such that the position is temporally synchronized with the position on the graph on which the first mark is displayed.

The display control unit 1003 may display state information temporally synchronized with the position on the graph on which the first mark is displayed. The state information may be information regarding the tilt of the mast 111 of the mobile body 110. The state information may be information regarding the rotation angle of the sail 113 of the mobile body 110.

The display control unit 1003 may automatically move the first mark along a time axis of the graph.

The display control unit 1003 may compare and display information regarding a first speed of a comparison subject with information regarding a second speed to be compared with the first speed. The display control unit 1003 may compare and display information regarding a first running direction of a comparison subject and information regarding a second running direction to be compared with the first running direction. The display control unit 1003 may compare and display first state information of the comparison subject and second state information to be compared with the first state information.

The display control unit 1003 may compare and display, by a graph, a temporal change in the first speed and a temporal change in the second speed. The display control unit 1003 may compare and display, by a graph, a temporal change in the first running direction and a temporal change in the second running direction. The display control unit 1003 may compare and display a temporal change in first cumulative windward height of the comparison subject and a temporal change in second cumulative windward height to be compared with the first cumulative windward height.

For example, functions of the display control unit 1003 may be implemented by causing the CPU 901 to execute a program stored in a storage apparatus such as the memory 902 depicted in FIG. 9, for example.

In this manner, the control unit of the display apparatus has the acquiring unit 1001 that acquires position information regarding changing positions of the mobile body 110 that moves by wind power; the data processing unit 1002 that based on the position information, calculates a speed of the mobile body at each of the positions and a running direction of the mobile body at each of the positions relative to a wind direction; and the display control unit 1003 that accumulates in a predetermined storage region, information regarding the speed and the running direction; and compares and displays first information accumulated regarding the speed and the running direction and second information narrowed down from the first information, based on types of tools used on the mobile body.

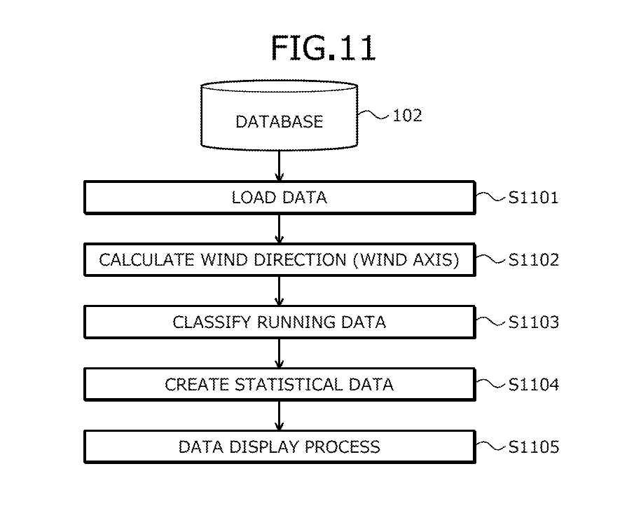

FIG. 11 is a flowchart of an example of a data display process procedure. In the flowchart depicted in FIG. 11, the display apparatus 103 first loads data from the database 102 (step S1101). The display apparatus 103 then calculates a wind direction (wind axis) based on the loaded data (step S1102).

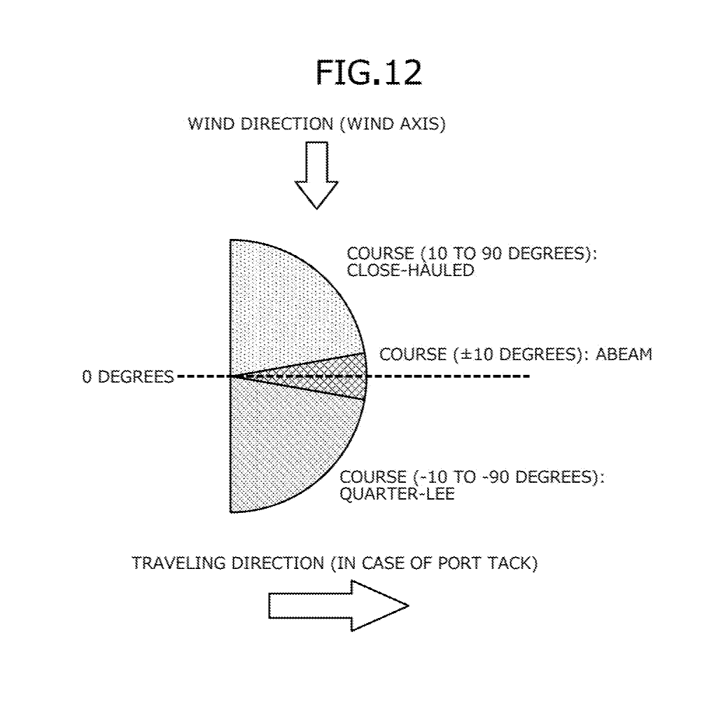

The display apparatus 103 classifies running data (step S1103). The display apparatus 103 sets a straight line orthogonal to the wind direction to zero degrees and classifies the data into three types from the “movement azimuth” of the GPS data, based on a judgment standard depicted in FIG. 12.

The display apparatus 103 creates statistical data (step S1104). The display apparatus 103 executes data statistical process, whereby a polar curve is displayed and all the GPS data of the same user is loaded and integrated. Subsequently, the display apparatus 103 calculates [highest speed, direction] and [various VMGs]. Velocity Made Good (VMG) is an effective speed and means a speed with respect to a desired direction (how far one is traveling in the desired direction). The display apparatus 103 also executes a jibe recognition process. A jibe is a turn under the wind.

Subsequently, the display apparatus 103 executes a data display process (step S1105), ending the series of operations.

FIG. 12 is an explanatory diagram of details of the classification of the running data. In FIG. 12, “abeam” is a course at ±10 degrees, i.e., running in a direction perpendicular to the wind; “close-hauled” is a course at 10° to 90°, i.e., running in a windward direction; and “quarter-lee” is a course at −10 degrees to −90 degrees, i.e., running in a leeward direction.

Additionally, two classifications are defined as “port tack”, which is the case of going in the rightward direction, and “starboard tack”, which is the case of going in the leftward direction, relative to the wind direction (wind axis). FIG. 12 depicts the case of “port tack”, and this is reversed left and right in the case of “starboard tack” and classified into three types as well.

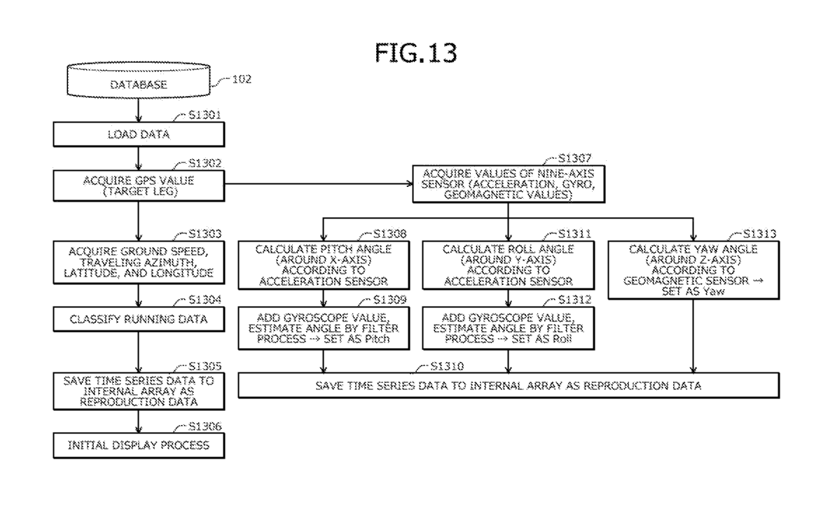

FIG. 13 is a flowchart of an example of an angle data calculation process procedure. In the flowchart depicted in FIG. 13, the display apparatus 103 first loads data from the database 102 (step S1301). The display apparatus 103 then acquires from the loaded data, the GPS value corresponding to a target leg (step S1302). Based on the acquired GPS value, the display apparatus 103 then acquires the ground speed, the traveling azimuth, the latitude, and the longitude (step S1303).

Subsequently, the display apparatus 103 classifies running data (step S1304). For example, based on the classification of the running data at step S1103 of the flowchart depicted in FIG. 11, the display apparatus 103 performs color coding according to the traveling direction.

The display apparatus 103 stores time series data to an internal array as reproduction data (step S1305). The display apparatus 103 executes an initial display process (step S1306). For example, the display apparatus 103 executes the process to connect plots of GPS point group data and consecutive points on a map with a line.

The display apparatus 103 acquires values of the nine-axis sensor 202 according to the GPS value for the target leg acquired at step S1302 (step S1307). The display apparatus 103 calculates a pitch angle that is an angle around the X-axis according to the acceleration sensor, among the acquired values of the nine-axis sensor 202 (step S1308).

Among the acquired values of the nine-axis sensor 202, the display apparatus 103 adds a gyroscope value from the gyro sensor, and estimates an angle by a filter process (step S1309). This angle is defined as the pitch angle. For example, the display apparatus 103 performs a process with a complementary filter, a linear Kalman filter, an unscented Kalman filter, etc. as the filter process.

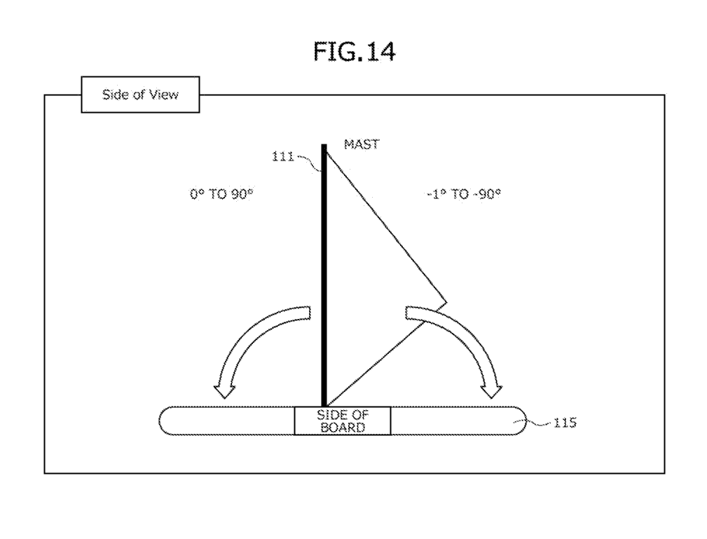

FIG. 14 is an explanatory view of details of the pitch angle calculation. FIG. 14 depicts a view of the sailboard 110 as seen from a side (Side of View). In FIG. 14, the pitch angle (Euler angle) is 0° when the mast 111 is perpendicular to the board unit 115, and a plus (0° to 90°) means a state in which the mast 111 is tilted forward, i.e., a tilt toward the nose side, from this state, while a minus (−1° to)−90° means a state in which the mast 111 is tilted backward, i.e., a tilt toward the tail side. This range is a range within which the pitch angle can be calculated.

The pitch angle can be calculated by equation (1).

Pitch angle=A TAN((ax)/SQRT(ay*ay+az*az)) (1)

ax: acceleration sensor value of the X-axis

ay: acceleration sensor value of the Y-axis

az: acceleration sensor value of the Z-axis

The display apparatus 103 calculates a roll angle that is an angle around the Y-axis according to the acceleration sensor, among the values of the nine-axis sensor 202 acquired at step S1307 (step S1311). Among the acquired values of the nine-axis sensor 202, the display apparatus 103 adds the gyroscope value from the gyro sensor, and estimates an angle by a filter process (step S1312). This angle is defined as the roll angle.

Similarly to the filter process used for estimating the roll angle, for example, the display apparatus 103 performs a process with a complementary filter, a linear Kalman filter, an unscented Kalman filter, etc. as the filter process.

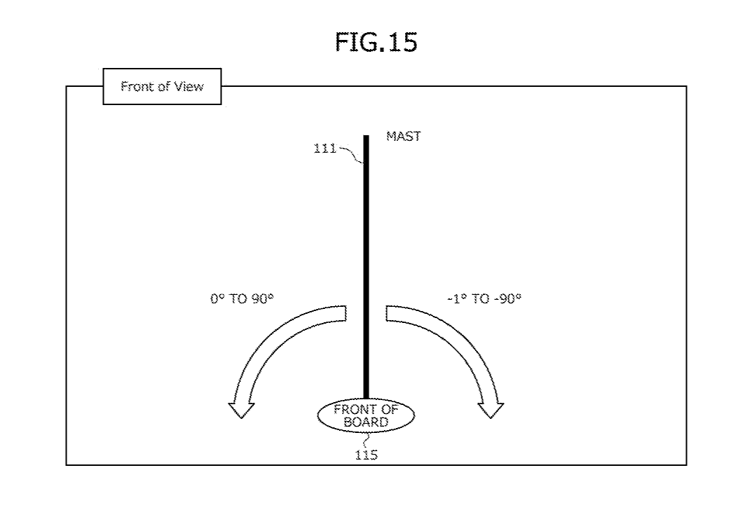

FIG. 15 is an explanatory view of details of the roll angle calculation. FIG. 15 depicts a view of the sailboard 110 as viewed from the front (nose side) (Front of View). In FIG. 15, the roll angle (Euler angle) is 0° when the mast 111 is perpendicular to the board unit 115, and a plus (0° to 90°) means a state in which the mast 111 is tilted toward the left side of the drawing, i.e., a tilt toward the left side of the board unit 115, from this state, while a minus (−1° to)−90° means a state in which the mast 111 is tilted toward the right side of the drawing, i.e., a tilt toward the right side of the board unit 115. This range is a range within which the roll angle may be calculated.

The roll angle can be calculated by equation (2).

Roll angle=A TAN((ay)/SQRT(ax*ax+az*az)) (2)

The display apparatus 103 calculates a yaw angle that is an angle around the Z axis according to the geomagnetic sensor, among the values of the nine-axis sensor 202 acquired at step S1307 (step S1313).

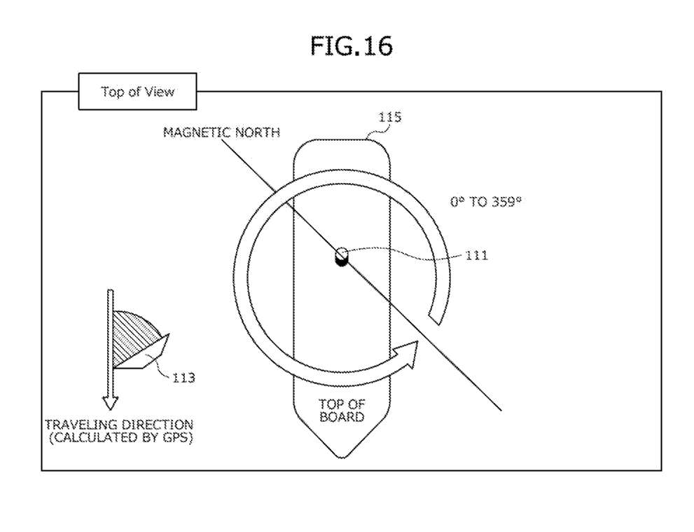

FIG. 16 is an explanatory diagram of details of the yaw angle calculation. FIG. 16 depicts a view of the sailboard 110 as viewed from above (Top of View). In FIG. 16, the yaw angle (Euler angle) is a rotation angle of the sail 113 based on the magnetic north around the mast 111. The angle is 0° at a position where the mast 111 side of the sail 113 faces the magnetic north, i.e., the position where the boom end side faces in a direction opposite to the magnetic north, and the angle may be calculated within a counterclockwise range from 0° to 359°.

Since the traveling direction may be calculated from the GPS, the rotation angle of the sail 113 may also be calculated by gyro correction using a low-pass filter process, based on the value of the geomagnetic sensor.

The yaw angle (Yaw) may be calculated by equations (3) to (5).

magX: geomagnetic sensor value of the X-axis

magY: geomagnetic sensor value of the Y-axis

Yaw=a tan 2(magX,magY);

if(Yaw<0)Yaw+=2*PI;

if(Yaw>2*PI)Yaw−=2*PI; (3)

Yaw=Yaw*180/M_PI; (4)

//adjust the magnetic deflection angle in the case of west deflection (Japan)

Yaw=Yaw+6.6; //magnetic deflection angle of 6.6 degrees

if(Yaw>360.0)Yaw=Yaw−360.0; (5)

Using the pitch angle estimated at step S1309, the roll angle estimated at step S1312, and the yaw angle calculated at step S1313 as the reproduction data, the display apparatus 103 stores time series data to the internal array (step S1310), ending the series of operations.

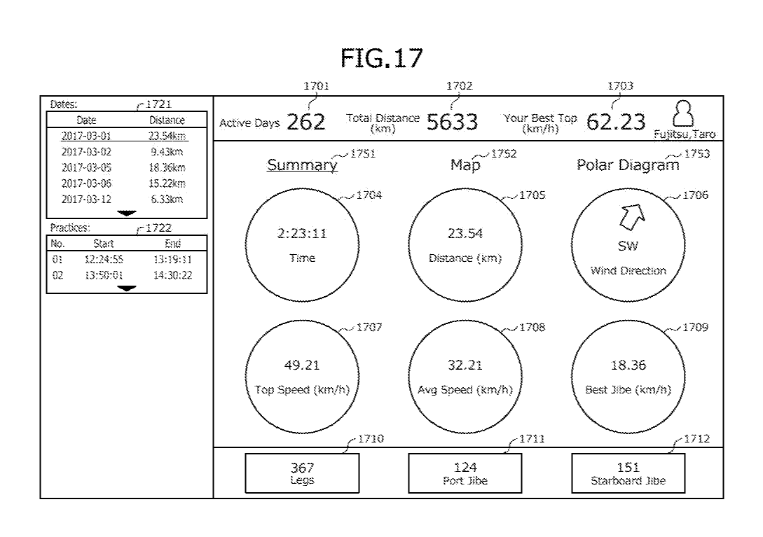

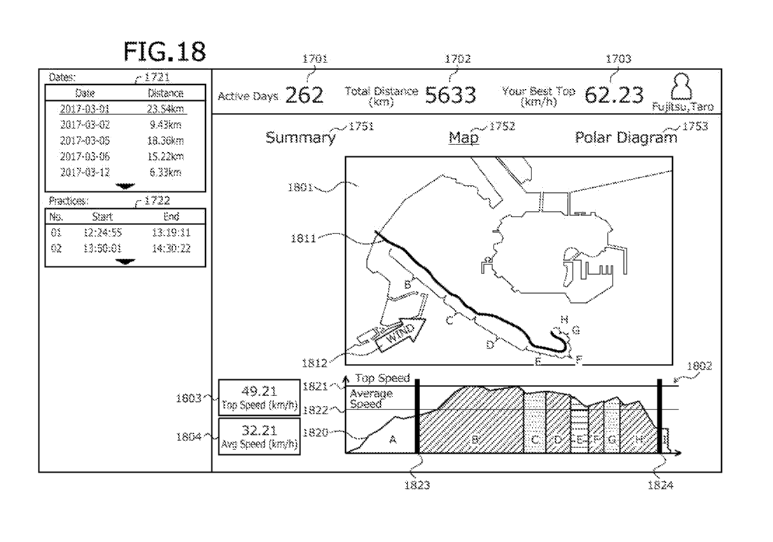

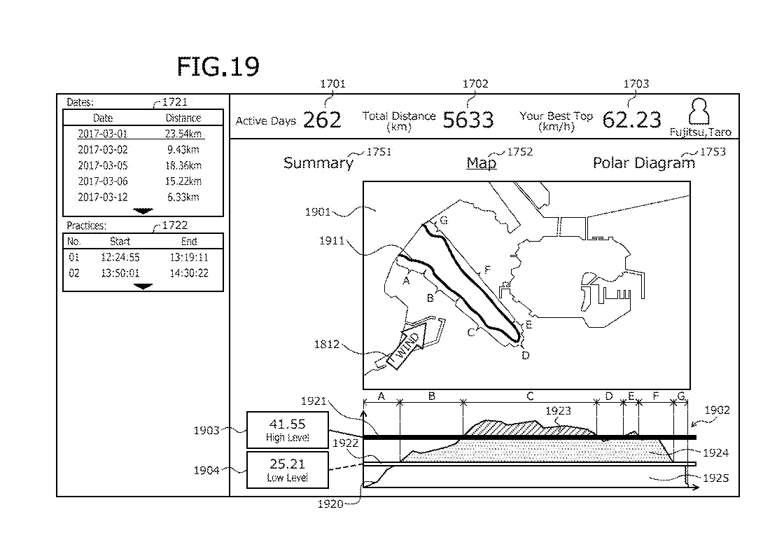

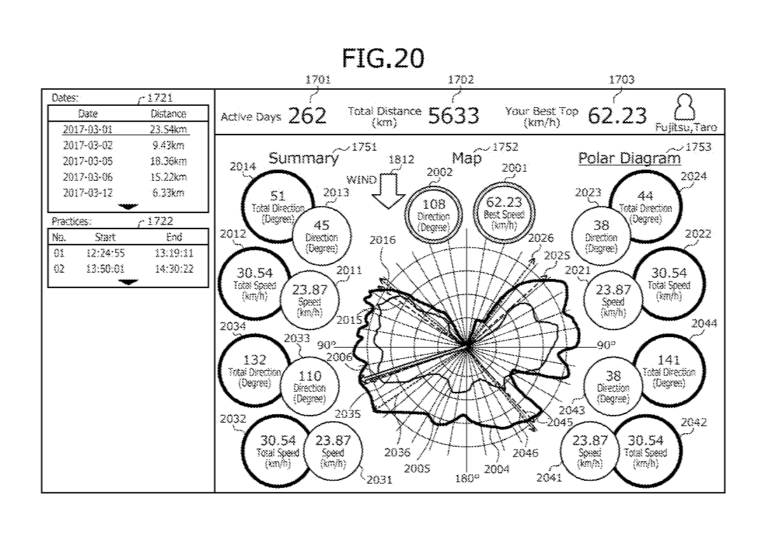

FIGS. 17, 18, 19, and 20 are explanatory views of contents of data display. FIG. 17 depicts an example of a summary display, FIGS. 18 and 19 depict an example of a map display, and FIG. 20 depicts an example of a polar diagram display.

FIG. 17 depicts the contents of the summary. In FIG. 17, “Active Days” 1701, “Total Distance” 1702, and “Your Best Top” 1703 are displayed in an upper field of a display screen.

The “Active Days” 1701 indicates the cumulative number of days of the user's sailing (practice) and the indicated number of days is “262 (days)”. The “Total Distance” 1702 indicates the cumulative distance of the user's sailing (riding on the sailboard 110) and the indicated distance is “5633 (km)”. The “Your Best Top” 1703 indicates the highest speed during the period of the cumulative number of days (distance) of the user's sailing and the indicated speed is “62.23 (km/h)” (62.23 km per hour).

In FIG. 17, “Time” 1704, “Distance” 1705, and “Wind Direction” 1706 are displayed from the left in an upper row in a main field of the display screen.

The “Time” 1704 indicates a time period for one day, i.e., the time period from the pressing of a sensor recording start button to the pressing of a recording end button, and the indicated time period is “2:23:11” (2 hours 23 minutes 11 seconds).

The “Distance” 1705 indicates a total distance of the user's sailing for one day, i.e., a distance sailed from the pressing of the sensor recording start button to the pressing of the recording end button, and the indicated distance is “23.54 (km)”. For the total distance, a value calculated from the GPS value may be used.

The “Wind Direction” 1706 indicates a wind direction predicted from the running data and is depicted as “SW” (southwest wind) and an arrow pointing in an upper right direction indicating southwest. For the wind direction, the direction calculated at step S1102 of the flowchart depicted in FIG. 11 may be used.

As described above, the upper row depicts objective information of sailing history not directly related to a sailing technique.

In FIG. 17, “Top Speed” 1707, “Avg Speed” 1708, and “Best Jibe” 1709 are displayed from the left in the lower row in the main field of the display screen. The “Top Speed” 1707 indicates the highest speed recorded in the one-day data and the indicated speed is “49.21 (km/h)” (49.21 km per hour). The “Avg Speed” 1708 indicates the average speed in the one-day data (excluding the land waiting time) and the indicated speed is “32.21 (km/h)” (32.21 km per hour).

The “Best Jibe” 1709 indicates the maximum escape speed in the jibes recorded in the one-day data, and the indicated speed is “18.36 (km/h)” (18.36 km per hour).

In FIG. 17, “Legs” 1710, “Port Jibe” 1711, and “Starboard Jibe” 1712 are displayed in a lower field under the main field of the display screen.

The “Legs” 1710 indicate the number of (a count of) Legs performed in the one-day data, and the indicated number is “367 (legs)”. The “Port Jibe” 1711 indicates the number of jibes from a port tack (a way of sailing while receiving wind from the left side of the board unit 115 with the left hand and the left foot in front), and the indicated number is “124 (times)”. The “Starboard Jibe” 1712 indicates the number of jibes from a starboard tack (a way of sailing while receiving wind from the right side of the board unit 115, contrary to the port tack, with the right hand and the right foot in front), and the indicated number is “151 (times)”.

The main field of the display screen displays the six items surrounded by circles. Since all the items have analog values, this enables intuitive comprehension of images of such analog values. The lower field of the display screen displays the three items surrounded by rectangles and, since all these items are digital values, this enables intuitive comprehension of images of such digital values. In this way, the displayed items may be changed in design to allow a user to intuitively and sensorially comprehend the data.

A left field of the display screen displays a list 1721 of summaries of the one-day data for each date. In this list 1721, dates (Date) and the total distance (Distance) of the user's sailing for one day are arranged in order of date. This list 1721 can be sorted and rearranged in ascending or descending order of the date (Date), or in ascending or descending order of the total distance (Distance). The one-day data may be displayed by selecting from the list, a summary (date) to be displayed.

In FIG. 17, displayed in descending order of the date (Date), “2017-03-01 23.54 km” at the top has been selected and is highlighted in the display, and it can be seen that the time “2:23:11” of the “Time” 1704 and the distance “23.54 (km)” of the “Distance” 1705 agree.

A list 1722 of summaries of multiple Practices in the one-day data selected in the list 1721 is displayed on the lower side of the list 1721 of summaries of the one-day data. The list 1722 displays a serial number (“No.”) for each Practice, the start time (“Start”) of the Practice, and the end time (“End”) of the Practice. The data of the corresponding Practice may be displayed by selecting from the list, a summary (Practice) to be displayed.

In FIG. 17, no summary (Practice) is selected and the display is not changed. When any of the summaries (Practices) is selected, the summary is highlighted, and the summary data of the items 1704 to 1712 in the main field and the lower field is accordingly narrowed down and displayed.

In FIG. 17, on the upper side of the main field of the display screen, screen switching buttons of “Summary” 1751, “Map” 1752, and “Polar Diagram” 1753 are provided. The “Summary” 1751 is the summary screen depicted in FIG. 17, the “Map” 1752 is a display screen that uses a map depicted in FIGS. 18 and 19, and the “Polar Diagram” 1753 is a display screen that uses a polar diagram depicted in FIG. 20.

Since the summary is displayed in FIG. 17, a form (including color) of display of “Summary” 1751 is different from the “Map” 1752 and the “Polar Diagram” 1753. By clicking or touching the positions of display of the “Map” 1752 and the “Polar Diagram” 1753 with a pointing device etc., or with a finger etc., the screen may be switched easily to the display screen depicted in FIGS. 18 and 19 or the display screen depicted in FIG. 20, respectively.

FIG. 18 depicts the contents of the map. FIG. 18 mainly depicts a map part 1801 along with a speed display part 1802 thereunder that displays a change in speed over time by a line graph 1820.

The “Active Days” 1701, the “Total Distance” 1702, and the “Your Best Top” 1703 in the upper field of the display screen display the same contents as those of FIG. 17. The list 1721 of summaries of one-day data in the left field of the display screen and the list 1722 of summaries of multiple Practices in the one-day data are also the same as those depicted in FIG. 7.

The screen switching buttons of the “Summary” 1751, the “Map” 1752, and the “Polar Diagram” 1753 on the upper side of the main field of the display screen are the same contents as those depicted in FIG. 17. In FIG. 18, since the map is displayed, the display form (color) of the “Map” 1752 is different from the “Summary” 1751 and the “Polar Diagram” 1753.

In FIG. 18, a locus 1811 of movement (sailing) of the sailboard 110 is displayed in the map part 1801. An arrow 1812 indicating the wind direction is also displayed.

In FIG. 18, in the speed display part 1802, the line graph 1820 indicating the speed is displayed, where the horizontal axis (X-axis) represents time and the vertical axis (Y-axis) represents speed. The vertical axis (Y-axis) is associated with two lines, which are a line (Top Speed) 1821 and a line (Average Speed) 1822 parallel to the horizontal axis (X-axis). The line (Top Speed) 1821 is a line indicating the highest speed. The line (Average Speed) 1822 is a line indicating the average speed. The highest speed and the average speed are displayed as the “Top Speed” 1803 and the “Avg Speed” 1804, respectively.

The horizontal axis (X-axis) is associated with two lines, which are a line 1823 indicating the start time of the display on the map and a line 1824 indicating the end time of the display on the map parallel to the vertical axis (Y-axis). Only a section between the two lines 1823 and 1824 is displayed as the locus in the map part 1801.

The line graph 1820 is classified into nine regions A to I. The region A is before the line 1823 and therefore not displayed on the map. Thus, the region is not color-coded or is indicated by color (e.g., gray) for differentiation from the other color-coded regions.

The regions B, D, F, and H indicate abeam. The regions of abeam may be colored in red, for example. The regions C and G indicate quarter-lee. The regions of the quarter-lee may be colored in blue, for example. The region E indicates close-hauled. The region of close-hauled can be colored in yellow, for example.

The region I is after the line 1824 and therefore, not displayed as the locus 1811 in the map part 1801. Thus, similar to the region A, the region is not color-coded or is indicated by a color such as gray, for example.

In this way, the regions B to H of the line graph 1820 of the speed display part 1802 are in the order of the region B: “abeam (red)”→the region C: “quarter-lee (blue)”→the region D: “abeam (red)”→the region E: “close-hauled (yellow)”→the region F: “abeam (red)”→the region G: “quarter-lee (blue)”→the region H: “abeam (red)”, and may be displayed in a color-coded manner according to a running type.

The locus 1811 of the movement (sailing) of the sailboard 110 is colored and displayed in the colors of the coloring in the speed display part 1802. As depicted in FIG. 18, the locus 1811 is colored in a section B in red, a section C in blue, a section D in red, a section E in yellow, a section F in red, a section G in blue, and a section H in red, so that the same colors are used as the regions B to H of the line graph 1820 of the speed display part 1802. As a result, the sailing types may be displayed separately by color.

With this configuration, the visuality of data may be improved. Therefore, the locus 1811 of the map part 1801 and the line graph 1820 of the speed display part 1802 are synchronized so that the speed at each position on the locus 1811 may be easily and intuitively comprehended, and what type of sailing was being performed may be instantaneously recognized. Therefore, how the running was being performed may be clearly comprehended and what type of sailing was being performed (close-hauled, abeam, quarter-lee, etc.) may be recognized.

In FIG. 19, as in FIG. 18, a map part 1901 and a speed display part 1902 are displayed. As in FIG. 18, the speed display part 1902 displays a line graph 1920 indicating changes in the speed, where the horizontal axis (X-axis) represents time and the vertical axis (Y-axis) represents speed. The vertical axis (Y-axis) is associated with two lines, which are a line (High Level) 1921 and a line (Low Level) 1922, parallel to the horizontal axis (X-axis).

The line (High Level) 1921 is a line indicating an upper limit speed. The line (Low Level) 1922 is a line indicating a lower limit speed. The upper limit speed “41.55 (km/h)” and the lower limit speed “25.21 (km/h)” are displayed in “High Level” 1903 and “Low Level” 1904, respectively.

The line graph 1920 is divided by the line (High Level) 1921 and the line (Low Level) 1922 into three regions (regions 1923, 1924, 1925). A region 1923 of speeds equal to or faster than the upper limit speed is depicted in red, a region 1924 of speeds less than the upper limit speed and equal to or faster the lower limit speed is depicted in blue, and the region 1925 of speeds slower than the lower limit speed is depicted in gray.

In FIG. 19, sections A to G are set based on intersections between the line graph 1920 and the lines 1921, 1922. For example, the sections A and G are the region 1925, the sections B, D, and F are the region 1924, and the sections C and E are the region 1923.

The locus 1911 of the map unit 1901 is color-coded for each of the sections A to G in synchronization with the color-coding of the speed display part 1902. The coloring is performed as follows: “section A: gray”→“section B: blue”→“section C: red”→“section D: blue”→“section E: red”→“section F: blue”→“section G: gray”.

With this configuration, as in FIG. 18, the locus 1911 of the map part 1901 is synchronized with the line graph 1920 of the speed display part 1902, and the speed at each position on the locus 1911 may be easily and intuitively comprehended.

FIG. 20 is an explanatory view of contents of a polar diagram. In FIG. 20, a polar diagram is displayed at a center with respect to a wind direction (WIND) indicated by the arrow 1812, and “Best Speed” 2001 and “Direction” 2002 are displayed above the center. The “Best Speed” 2001 indicates a user's highest speed in the past, and the highest speed is indicated to be “62.23 (km/h)”. The “Direction” 2002 indicates the angle at the time of the highest speed in the past, and the angle is indicated to be “108°)”.

In a periphery of the polar diagram, four circular displays indicating numerical values are displayed in respective regions on the upper left, upper right, lower left, and lower right sides.

On the upper left side of the drawing, upwind “Speed” 2011, “Total Speed” 2012, “Direction” 2013, and “Total Direction” 2014 of the upwind VMG starboard tack of the selected day are displayed.

The “Speed” 2011 indicates the upwind speed of the upwind VMG starboard tack of the day, and the speed is indicated to be “23.87 (km/h)”. The “Total Speed” 2012 indicates the cumulative upwind speed of the upwind VMG starboard tack, and the speed is indicated to be “30.54 (km/h)”.

The “Direction” 2013 indicates the upwind angle of the upwind VMG starboard tack of the day, and the angle is indicated to be “45°”. The “Total Direction” 2014 indicates the cumulative upward angle of the upwind VMG starboard tack, and the angle is indicated to be “51°”.

As depicted in FIG. 20, the circle indicating the cumulative value is displayed to be larger than and on the outer side of the value of the selected day, thereby giving an image that the value of the selected day is a portion of the cumulative value so that one may intuitively comprehend which is the value of the selected date and which is the cumulative value. Furthermore, this may be made clearer by changing the color of the border of the circle.

On the upper right side of the drawing, upwind “Speed” 2021, “Total Speed” 2022, “Direction” 2023, and “Total Direction” 2024 of the upwind VMG port tack of the selected day are displayed.

On the lower left side of the drawing, upwind “Speed” 2031, “Total Speed” 2032, “Direction” 2033, and “Total Direction” 2034 of the leeward VMG starboard tack on the selected day are displayed.

On the lower right side of the drawing, upwind “Speed” 2041, “Total Speed” 2042, “Direction” 2043, and “Total Direction” 2044 of the leeward VMG port tack of the selected day are displayed.

A line 2004 indicates the polar curve of the selected day, and a line 2005 indicates the cumulative polar curve. An arrow 2006 indicates the vector of the highest speed in the past. An arrow 2015 indicates a vector of the upwind VMG starboard tack of the selected day, and an arrow 2016 depicts the cumulative vector of the upwind VMG starboard tack. The speed is indicated by the length of the arrows, and the angle is indicated by the direction pointed by the arrows.

Similarly, an arrow 2025 indicates the vector of the upwind VMG port tack of the selected day and an arrow 2026 indicates the cumulative vector of the upwind VMG port tack. An arrow 2035 indicates the vector of the leeward VMG starboard tack of the selected day, and an arrow 2036 indicates the cumulative vector of the leeward VMG starboard tack. An arrow 2045 indicates the vector of the leeward VMG port tack on the selected day and an arrow 2046 indicates the cumulative vector of the leeward VMG port tack.

This can be used as a reference for comprehending the characteristics (habit, strong/weak points) of user's riding with respect to the wind direction.

“Active Days” 1701, “Total Distance” 1702, and “Your Best Top” 1703 in the upper field of the display screen display the same contents as in FIGS. 17 to 19. The list 1721 of summaries of one-day data in the left field of the display screen and the list 1722 of summaries of multiple Practices in the one-day data are also the same as those in FIGS. 17 to 19.

The screen switching buttons of the “Summary” 1751, the “Map” 1752, and the “Polar Diagram” 1753 on the upper side of the main field of the display screen are the same contents as in FIGS. 17 to 19. In FIG. 20, since the polar diagram is displayed, the form (color) of display of the “Polar Diagram” 1753 is different from the “Summary” 1751 and the “Map” 1752.

In this way, the polar curve may be drawn according to the acquired information (board speed, direction) from GPS, and what way of riding was being performed with what kind of tool at that time may be recorded.

As a result, although only the highest speed and the average speed may be compared in conventional GPS products, the sailing ability may be evaluated visually and objectively through visualization. Therefore, a factor of improvement may be comprehended. For example, the VMG and the highest speed may be improved under the same condition of the tool/wind speed. Additionally, it may be confirmed that the way of riding has improved. For example, the VMG and the highest speed may be improved in the same way of riding/at the same wind speed. Moreover, it may be confirmed that an improvement is achieved with a tool.

Description will be made of consideration of a portion where running data (speed, angle) depends on factors other than the way of riding. By simultaneously recording information regarding tools used for sailing in sailing information, a bias of difference of the tools may be reduced.

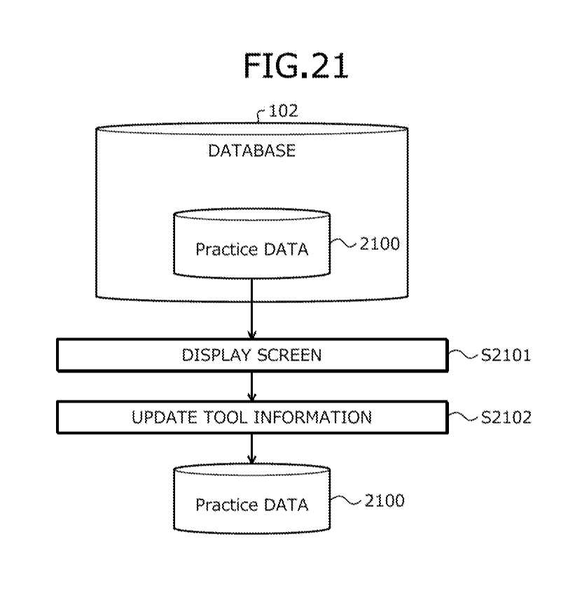

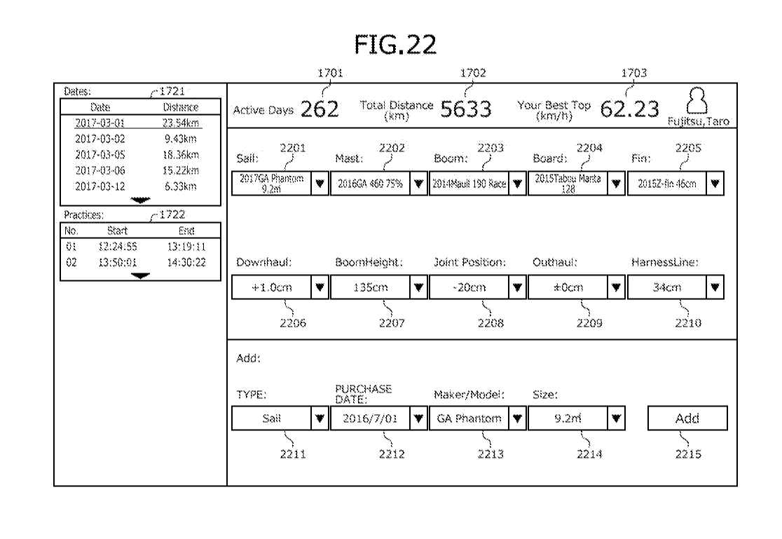

For this purpose, tools used are first recorded. Information regarding tools used for sailing is recorded. FIG. 21 is a flowchart of an example of a tool registration/editing process procedure. In the flowchart of FIG. 21, first, one-day Practice data 2100 is read from the database 102 and a screen is displayed (step S2101). Details of the screen will be described with reference to FIG. 22.

When tool information is included in GPS data displayed on the screen, the information is displayed. When no tool information is included, a blank is displayed, thereby making it easy to know whether tool information is already registered.

The tool information is then updated (or registered) (step S2102). For example, at the time of a tool information pull-down operation on the screen, GPS log data is updated. Configuration may be such that when the Practice is narrowed down, tool data is updated for only the corresponding Practice number.

In this way, the tool information may be updated (or registered) in the Practice data 2100.

The contents of tool registration screen will be described. FIG. 22 is an explanatory diagram of the contents of the tool registration screen. In FIG. 22, first, desired one-day data is specified from the list 1721 of summaries of one-day data. In this way, the tools used may be registered on a daily basis.

When data is specified, already registered data is displayed in each of input fields 2201 to 2214. No data is displayed in an input field without registration. The upper five input fields 2201 to 2205 are for the five main tools (the sail 2201, the mast 2202, the boom 2203, the board 2204, and the fin 2205). The names, etc. of the tools used on the current day are displayed in the input fields.

When the contents are to be updated (changed), a pull-down button on the right side is pressed to display other names already registered for each input field. Any of the names may be selected to change the contents.

If nothing is displayed due to absence of registration, registration may be newly performed from an “Add:” field on the lower side. For example, a type (tool type) is selected from the pull-down menu 2211, and the date of purchase is entered in the input field 2212. The manufacturer and the model of the tool are also input (selected) in the input field 2213. The size is also input (selected) in the input field 2214. After input is completed, an “Add” button (registration button) 2215 is pressed to complete the registration. After the registration, the registered information regarding the tools is displayed in the pull-down menus of the input fields 2201 to 2205.

On the lower side of the input fields of the main five tools, input fields are displayed for tuning elements (a down amount 2206, a boom height 2207, a joint position 2208, an outhaul tension amount 2209, and a harness line length 2210).

The tools used may be edited on the basis of Practice displayed in the list 1722 of summaries of Practice. By selecting the Practice displayed in the list 1722 of summaries of Practice and performing the same operation as described above, the update (or registration) may be performed.

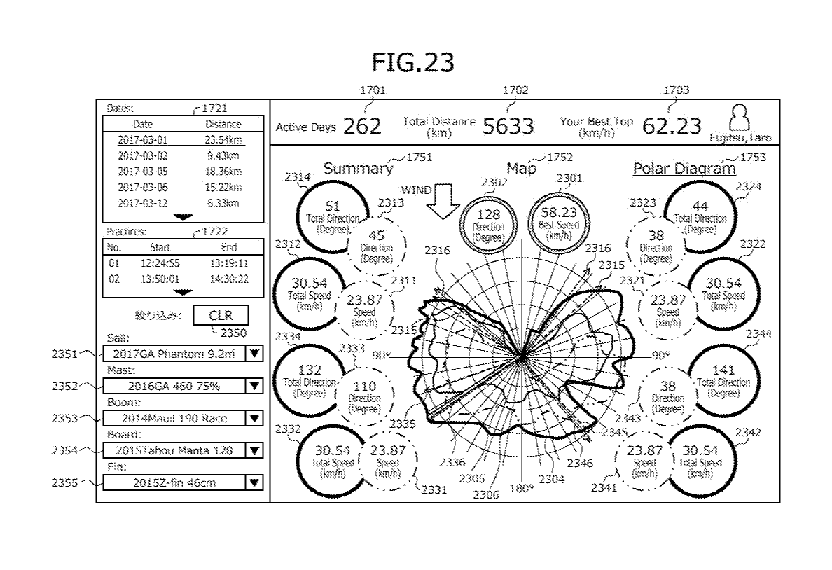

FIG. 23 is an explanatory view of the contents of data display. The basic configuration is the same as the contents of FIG. 20.

By using narrow-down fields 2351 to 2355, the tools (sail: 2351, mast: 2352, boom: 2353, board: 2354, fin: 2355) may be narrowed down. By pressing a “CLR” button 2350, the narrowing-down is all cleared.

For example, when only the fin is selected while the other fields are blank, the performance of the fin may be comprehended from the result. By combining multiple tools, an optimum combination pattern may easily be found.

When at least one of the pull-down menus of the narrow-down fields 2351 to 2355 is selected to specify a tool, cumulative data (second data) of usage of the specified tool is displayed among the overall cumulative data (first data).

In FIG. 23, inner small circular displays 2301, 2302, 2311, 2313, 2321, 2323, 2331, 2333, 2341, 2343 are respective displays of the second data. Outer large circular displays 2312, 2314, 2322, 2324, 2332, 2334, 2342, 2344 are respective displays of the first data.

The circular displays of the second data are located further on the inner side than are the circular displays of the first data so as to provide intuitive understanding of an image that the second data is a comparison subject while the first data is for comparison. The circles of the second data are made smaller than the circles of the first data so as to provide intuitive understanding of an image that the second data is acquired by narrowing down the first data.

Similarly, a polar curve and a vector may be confirmed by comparing a polar curve according to the second data with the first data. It can be seen that a cumulative polar curve (second data) 2304 is changed to a cumulative polar curve (first data) 2306 due to narrowing-down. A highest speed vector 2336 is also changed due to narrowing-down.

The other contents are the same as FIG. 20 and therefore, will not be described in detail.

With such a configuration, the performance of the tools may be confirmed numerically, and the tools suitable for the sailing aimed at by the rider himself/herself may be selected. Differences due to tool tuning may be confirmed with objective data from subjective intervals, so that a more effective strategy may be developed for racing.

Since manufacturers of tools also develop products while repeating experiments with the same tester, the way of riding by the tester may be standardized to numerically manage what kind of performance the products provide. As a result, the development and productivity of the tools may be improved.

As described above, in the embodiment, the speed of the mobile body at each position and the running direction of the sailboard 110 relative to the wind direction are calculated based on the position information from the GPS value of the sailboard 110, and the speed and the running direction are displayed together with other data, so that the data may be compared. Since the state information regarding the state of the mobile body at each position according to the nine-axis sensor 202 is acquired and the state information is displayed in state display parts 2112, 2113 together with the information related to other data, the data can be compared, and the contents of the display data may be comprehended more reliably. Since narrowing-down may be performed for each tool and the comparison data thereof may be displayed, this may be used as a reference for selecting a tool.

With such a configuration, a visual confirmation may be made in terms of the relationship of the speed, the running direction, and the position on the map as well as the running state, or particularly, the stability of the sail, and the form may be converted into data and may also be compared easily with other data, a model of an optimum form may be created. As a result, efficient steering/running may be supported to improve a steering technique of windsurfing.

In this embodiment, the sailboard has been described as a mobile body that moves by wind power; however, the present invention is not limited thereto, and the mobile body may be a sailing object such as a yacht, for example. The mobile body is not limited to a mobile body on water and may be an object sailing on land.

The display method described in the present embodiment may be implemented by executing a prepared program on a computer such as a personal computer and a workstation. The display program is stored on a non-transitory, computer-readable recording medium such as a hard disk, a flexible disk, a compact disc (CD)-ROM, a magneto-optical disk (MO), a digital versatile disk (DVD), and a universal serial bus (USB) memory, is read out from the computer-readable medium, and executed by the computer. The program may be distributed through a network such as the Internet.

According to an aspect of the present invention, efficient steering/running may be supported.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory, computer-readable recording medium storing therein a display program that causes a computer to execute a process comprising:
acquiring position information regarding changing positions of a mobile body that moves by wind power;
calculating based on the position information, a speed of the mobile body at each of the positions and a running direction of the mobile body at each of the positions relative to a wind direction;
accumulating information regarding the speed and the running direction; and
comparing and displaying first information accumulated regarding the speed and the running direction and second information narrowed down from the first information, based on a plurality of types of tools used on the mobile body.

2. The recording medium according to claim 1, the process further comprising
receiving input of information regarding a tool used, wherein
the second information is defined as accumulated information regarding the speed and the running direction of the mobile body on which the tool corresponding to the input information is used.

3. The recording medium according to claim 1, the process further comprising
registering/updating information regarding a tool used with respect to the first information.

4. The recording medium according to claim 1, wherein
the position information is acquired by acquiring a GPS value.

5. A display method executed by a computer, the display method comprising:
acquiring position information regarding changing positions of a mobile body that moves by wind power;
calculating based on the position information, a speed of the mobile body at each of the positions and a running direction of the mobile body at each of the positions relative to a wind direction;
accumulating information regarding the speed and the running direction; and
comparing and displaying first information accumulated regarding the speed and the running direction and second information narrowed down from the first information based on a plurality of types of tools used on the mobile body.

6. A display apparatus comprising:
a memory;
a processor coupled to the memory, the processor configured to:
acquire position information regarding changing positions of a mobile body that moves by wind power;
calculate based on the position information, a speed of the mobile body at each of the positions and a running direction of the mobile body at each of the positions relative to a wind direction;
accumulate information regarding the speed and the running direction; and
compare and display first information accumulated regarding the speed and the running direction and second information narrowed down from the first information based on a plurality of types of tools used on the mobile body.
